(19) United States
(12) Patent Application Publication
(10) Pub. No.: US 2009/0119697 A1
(43) Pub. Date: May 7, 2009

(54) DISTRIBUTION DEVICE, DISTRIBUTION SYSTEM, AND DISTRIBUTION METHOD

(76) Inventors: Ken NOMURA, Yokohama (JP); Hiroshi Mine, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/099,252

(22) Filed: Apr. 8, 2008

(30) Foreign Application Priority Data
Apr. 9, 2007 (JP) 2007-101884

(51) Int. Cl. H04N 7/16

(52) U.S. Cl. 725/25

(57) ABSTRACT

A video distribution device that has a distribution judgment reference input function and a distribution judgment function, and can set different viewing limitations for different motion picture titles. Viewing limitations set viewable scenes and unviewable scenes in one motion picture title. Since the range of viewing limitations can be dynamically generated from access history, the motion pictures can be used for promotion, such as automatically extracting popular scenes for limited release. A viewing limitation range is reasonably decided based on more information by an interface for acquiring information such as access history from the outside. Furthermore, by embedding information of a link to another site in motion picture fragments limitedly released, viewers of the motion picture fragments can be guided to another site in which the whole motion picture can be viewed.

### CLAIM OF PRIORITY

The present application claims priority from Japanese patent application serial no. 2007-101884, filed on Apr. 9, 2007, the content of which is hereby incorporated by reference into this application.

### BACKGROUND OF THE INVENTION

The present invention relates to a distribution system and a distribution method, and more particularly to a device, a system, and a method for distributing still pictures or motion pictures.

Recently, video distribution business is being started on a next generation network called NGN. Unlike traditional Internet, NGN has functions advantageous to accounting, such as a quality of service (QoS) guarantee function and an authentication function that can guarantee a network band necessary for the transmission of videos, and can create a large-scale video distribution network. However, a large number of free-of-charge video distribution services already exist on the Internet, and the largest distribution company has ten million or more users. In such a circumstance, it is conceivable that the above-described NGN specific functions alone do not play a decisive role in success in business.

Video distribution services that collect the largest number of users on the Internet are services called a motion picture sharing type. Under services of the motion picture sharing type, motion pictured photographed and created by users themselves are uploaded to be released to other users. Generally, image contents handled in the services of the motion picture sharing type are poor in image quality and limited in reproduction time (length of motion pictures). However, the services are used on a free-of-charge basis, and have the function of commenting freely on uploaded motion pictures, the function of reading comments given by other users, the function of ranking the popularity of motion pictures, the function of pasting any motion pictures to blogs on other sites. These functions do not improve the quality of motion pictures but contribute to the formation of a user community on motion pictures. That is, this means that improvements in the quality of motion pictures are not the sole means to satisfy user needs.

With this background, to lead video distribution services on NGN to success, there is a problem of how to link existing motion picture communities of the Internet with high-quality motion picture distribution services on NGN. In view of the example of success in the services of the motion picture sharing type, the method of releasing free part of motion pictures is considered effective. This is because motion picture evaluation pages (BLOG) produced by motion picture users who well understand the appeal of motion pictures have the influence of causing readers to have interest in the motion pictures, and effective use of them enables more inexpensive advertisement than normal promotion. In video distribution intended for such promotion, the function of limitedly releasing only part of videos is effective.

In JP-A No. 032530/2004, viewing limitation for each video title such as videos prohibited for anyone under 18 years old is described. However, with the technology described in JP-A No. 032530/2004, part of a same title cannot be limited in viewing. With the methods described in JP-A No. 244678/2003 or JP-A No. 204536/2003, part of a same title can be viewed. However, with the technology described in JP-A No. 244678/2003 or JP-A No. 204536/2003, viewing cannot be limited. In other words, with existing technologies, video data extracted for viewing by editing videos in advance must be provided to perform viewing limitation such as releasing only part of videos.

With combinations of the conventional technologies, specific scenes in one same motion picture cannot be limited in viewing. Therefore, when only part of motion pictures is to be released for promotion or the like, motion pictures for release must be created additionally by editing original motion pictures in advance. It is difficult with the traditional technologies to place limitation criteria such as dynamically determining a viewing limitation range, particularly, such as releasing only popular scenes.

### SUMMARY OF THE INVENTION

The present invention solves this problem by realizing a video distribution device that is applicable also to promotion by having the function to enable the limitation of the viewing of specific scenes in an identical motion picture.

The above-described problem can be solved by a distribution device including a distribution judgment unit that distributes video data stored in a storage unit to end users via a network, and determines whether distribution is legal based on distribution judgment criteria received from a management terminal, and a motion picture distribution unit that transmits motion picture data with a limitation imposed on video data to a first user.

Also, the problem can be solved by a distribution system including a first distribution device connected to a first network, and a second distribution device connected to a second network, wherein the first distribution device includes a distribution judgment unit that determines whether distribution is legal based on distribution judgment criteria received from the management terminal, and a motion picture distribution unit that transmits first motion picture data with a limitation imposed on video data to a first user, based on a distribution request received from the first user, and the judgment of the distribution judgment unit, and wherein the second distribution device transmits second motion picture data corresponding to a link attached to the first motion picture data to the first user.

Furthermore, the problem can be solved by a distribution method including the steps of: receiving a distribution request form a user; determining whether distribution is legal, for the distribution request; and transmitting links to first motion picture data with a limitation imposed on video data, and second motion picture data with no limitation imposed to the user.

### BRIEF DESCRIPTION OF THE DRAWING

Preferred embodiments of the present invention will now be described in conjunction with the accompanying drawings, in which;

FIG. 1 is a block diagram of a video distribution system;

FIG. 2 is a detailed block diagram of a video distribution system;

FIG. 3 is an overall operation sequence diagram among a user terminal, WEB server, video distribution server, limited distribution server, and management terminal;

FIG. 4 is an operation sequence diagram including internal operations of a user terminal, BLOG owner terminal, management terminal, video distribution server, and limited distribution server;

FIG. 5 is a drawing for explaining distribution limitation criteria;

FIG. 6 is a drawing for explaining link information;

FIG. 7 is a drawing for explaining a thumbnail request;

FIG. 8 is a drawing for explaining a motion picture request;

FIG. 9A and FIG. 9B are drawings for explaining access history information;

FIG. 10 is a processing sequence diagram of a user terminal;

FIG. 11 is an operation flowchart of a distribution request receiving unit;

FIG. 12 is an operation flow of a distribution judgment unit;

FIG. 13A and FIG. 13B are drawings for explaining the determination of distribution judgment based on release rates;

FIG. 14A and FIG. 14B are drawings for explaining the determination of distribution judgment based on continuous reproduction time;

FIGS. 15A and 15B are drawings for explaining the determination of distribution judgment based on release prohibition sections;

FIGS. 16A, 16B, and 16C are drawings for explaining the determination of distribution judgment based on the order of popular scenes;

FIG. 17 is a block diagram of an MPEG stream;

FIG. 18 is a block diagram of an MPEG stream;

FIG. 19 is a block diagram of a video distribution system; and

FIG. 20 is a block diagram of a video distribution system.

### DESCRIPTION OF THE PREFERRED EMBODIMENTS

Hereinafter, preferred embodiments will be described with reference to the accompanying drawings. Identical reference numerals are assigned to substantially identical portions, and their descriptions are not repeated.

### First Embodiment

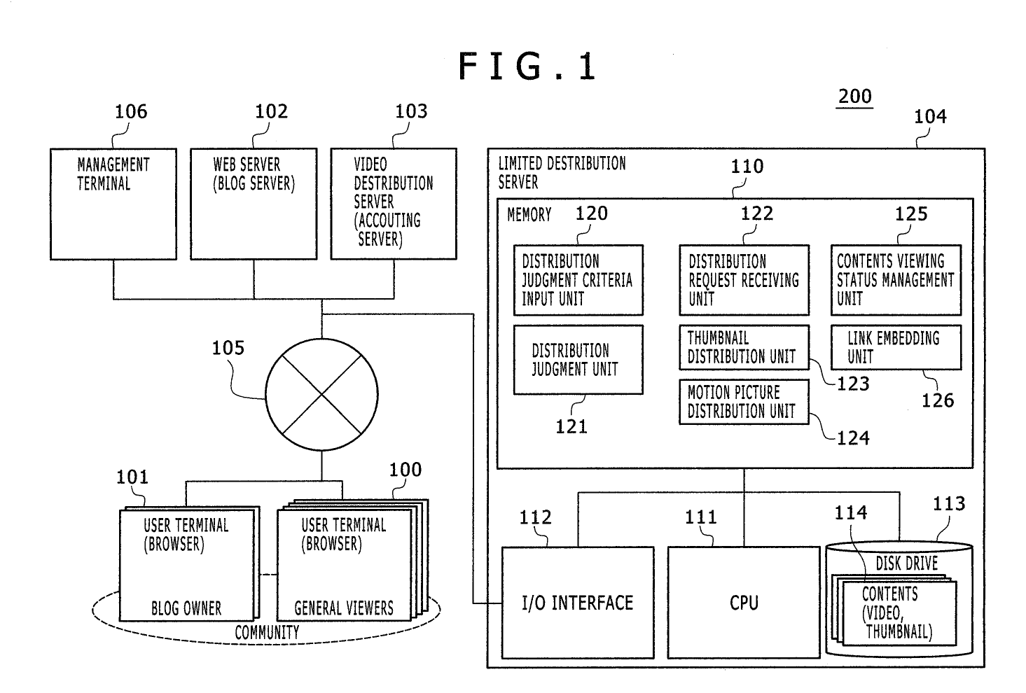

A limited distribution system is described with reference to FIG. 1. FIG. 1 is a block diagram of a video distribution system. In FIG. 1, a video distribution system 200 has plural user terminals 100 connected to a WEB server 102, a video distribution server 103, and a limited distribution server 104 via a network 105. A management terminal 106 is also connected to the network 105.

The user terminals 100 include user terminals 101 of users who play a main role in a motion picture community, such as BLOG owners. The number of BLOG owners is smaller than the number of general users. On the other hand, service providers include the existing BLOG server 102, the video distribution server 103 for accounting, the limited distribution server 104, and the management server 106.

The limited distribution server 104 includes hardware such as memory 110, CPU 111, I/O interface 112, and disk drive 113, and software such as contents (motion pictures and still picture data) 114, a distribution judgment criteria input unit 120 that is held on the memory and implements various functions in conjunction with the CPU and the I/O interface, a distribution judgment unit 121, a distribution request receiving unit 122, a thumbnail distribution unit 123, a motion picture distribution unit 124, a contents viewing status management unit 125, and a link embedding unit 126.

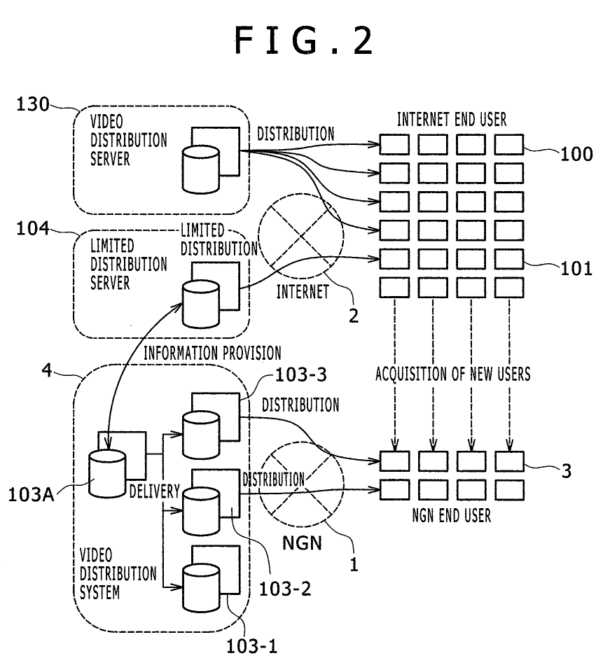

Promotion to a large-scale video distribution system is described with reference to FIG. 2.

FIG. 2 is a detailed block diagram of a video distribution system. The network 105 of FIG. 1 can actually fall into two categories of advanced networks such as NGN 1 that can keep the quality of motion pictures constant by assuring a network bandwidth, and networks of best effort type such as the Internet 2. Since the NGN 1 can assure (QoS assurance) a band necessary for video transmission, a large-scale video distribution system 4 based on accounting can be created. However, in the Internet 2, accounting is difficult because of difficulty in quality assurance.

In FIG. 2, a video distribution server 130 and the user terminals 100 and 101 are connected to the Internet 2. A video is transmitted from the video distribution server 130 to the user terminals 100 and 101 via the Internet 2. The video distribution server 130 is a server of prior art. On the other hand, the video distribution system 4 is connected to the NGN 1. A video is transmitted from the video distribution system 4 to the user terminal 3 via the NGN 1. The video distribution system 4 includes plural video distribution servers 103, and a video distribution server 103A that distributes videos to the video distribution server. The limited distribution server 104 connected with the video distribution server 103A is connected to the Internet 2. The limited distribution server 104 limitedly distributes videos offered from the video distribution server 103A to the user terminals 100 and 101 via the Internet 2. The limited distribution server 104 and the video distribution server 103A mutually exchange popular contents information and information such as change of release range.

In the Internet 2, existing video distribution service has already collected 50,000,000 or more end users worldwide. However, the new-comer NGN 1 must collect end users from now on. The limited distribution server 104 promotes NGN service by limitedly releasing parts of offered contents to the user terminals 100 and 101 of an existing user community. Since latent customers of NGN service probably exist among users who view existing low-quality motion pictures on the Internet, new users can be expected to be acquired efficiently by the above-described promotion. Since access history and popular contents information can be exchanged between the limited distribution server 104 and the distribution server 103A on the NGN 1, a viewing limitation range can be flexibly controlled, for example, by expanding the release range of unpopular contents.

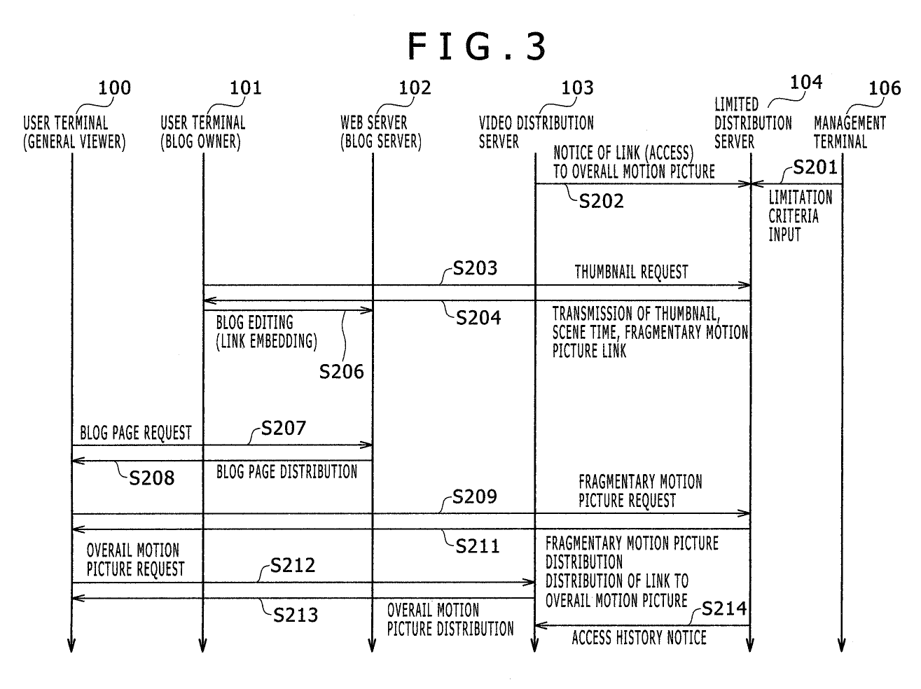

The following describes promotion to the NGN with reference to FIG. 3. FIG. 3 is an overall operation sequence diagram among a user terminal, a WEB server, a video distribution server, a limited distribution server, and a management terminal. In FIG. 3, the limited distribution server 104 is inputted in advance with a limitation method (limitation criteria) of a viewing range from the management terminal 106 (S201). Input of limitation criteria can be executed at any time such as during motion picture distribution. The video distribution server 103 sends link information such as information of link (access destination) to contents being distributed in the video distribution server 103 to the limitation distribution server 104 (S202). The link information is embedded in a motion picture in a step described later before being distributed to the user terminals 100. In a stationary state, the limited distribution server 104 waits for an image distribution request from the user terminal 100 or 101.

The user terminal 101 is the terminal of a user who produces contents such as BLOG on a motion picture community. Hereinafter, the user of the user terminal 101 is called a BLOG owner to distinguish from general users. The BLOG owner produces his own BLOG pages by using motion picture fragments and still pictures limitedly released by the limited distribution server 104 with the user terminal 101. Since the BLOG page producing operation has an advertising effectiveness, it also provides a merit to distribution service providers by the video distribution server 103. That is, placing parts of motion pictures on BLOG pages to increase the value of the BLOG pages has the aspect of increasing the advertising effectiveness of the images. By providing still pictures (thumbnail) of individual scenes of motion pictures and time information of the scenes, BLOG owners can produce BLOG pages (HTML document) embedded with specific scenes of the motion pictures without viewing the motion pictures themselves. By providing still pictures in advance, motion picture viewing limitation is enabled that releases only popular scenes after confirming scenes having high use needs in BLOG.

Specifically, the BLOG owner connects to the limited distribution server 104 by operating the user terminal 101. The user terminal 101 transmits a thumbnail request to the limited distribution server 104 (S203). On receiving the thumbnail request, the limited distribution server 104 transmits a requested thumbnail, scene time, and link destination to a fragmentary motion picture to the user terminal 101 (S204). By operations of the BLOG owner, the user terminal produces BLOG on the WEB server 102 (S206). In the BLOG, a thumbnail is displayed and a link to fragmentary motion pictures is embedded. The produced BLOG pages are uploaded into the BLOG server 102 and released to the entire Internet. The BLOG pages released to the entire Internet can be viewed by general users, using the user terminal 100.

By operations of general viewers, the user terminal 100 accesses the WEB server 102 and requests BLOG pages produced by the BLOG owner (S207). The WEB server 102b from which the BLOG pages are requested distributes the BLOG pages to the user terminal 100 (S208). In the BLOG pages, a thumbnail embedded with link information acquired in Step 204 from the limited distribution server 104 is displayed. When a user who is interested in the thumbnail placed on the BLOG pages clicks the link, the user terminal 100 transmits a fragmentary motion picture request to the limited distribution server 104 (S209). On receiving the fragmentary motion picture request, the limited distribution server 104 distributes links to fragmentary motion pictures and whole motion pictures to the user terminal 100 (S211). When a user who is interested in the fragmentary motion pictures clicks the links, the user terminal 100 transmits a whole motion picture request to the video distribution server 103 (S212). On receiving the whole motion picture request, the video distribution server 103 distributes a whole motion picture to the user terminal 100 (S213). At this time, access history information is provided from the limited distribution server 104 to the video distribution server 103 (S214).

The access history information contains information such as the number of distributions of the links, the number of clicks of the links, and the address of a user terminal that clicked the links, and can aid in improvement in video distribution service and function expansion such as prediction of access to the video distribution server, and the provision of discount service to users who visit via links.

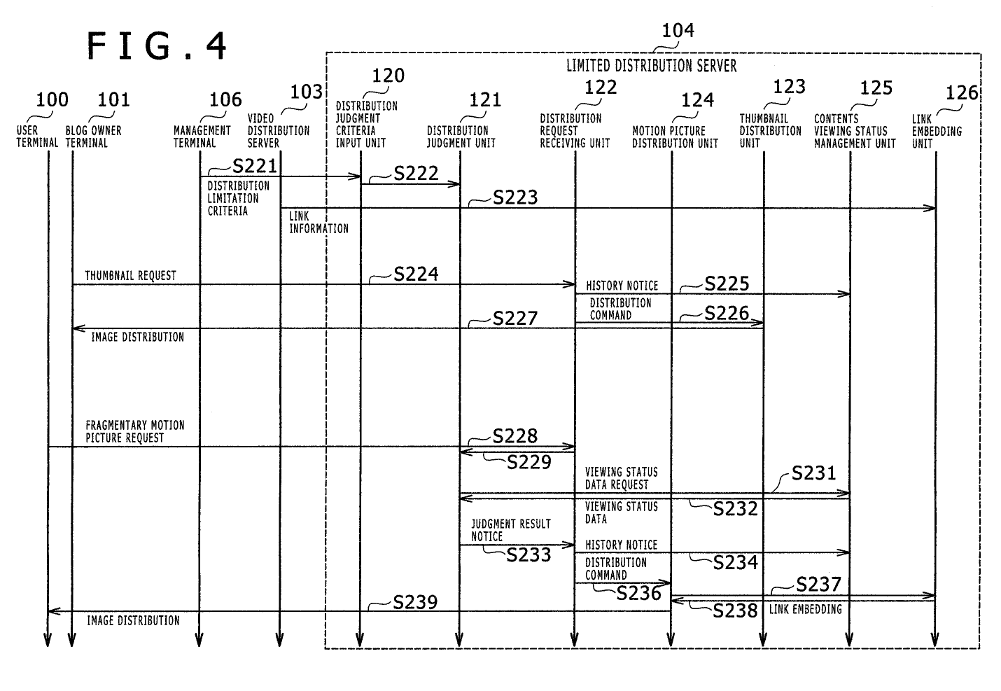

FIG. 4 is an operation sequence diagram including internal operations of a user terminal, a BLOG owner terminal, a management terminal, a video distribution server, and a limited distribution server. In FIG. 4, the management terminal 106 transmits distribution limitation criteria to the limited distribution server 104 (S221). The limited distribution server 104 receives the distribution limitation criteria in the distribution judgment criteria input unit 120, and transfers them to the distribution judgment unit 121 (S222). The video distribution server 103 transmits link information to the limited distribution server 104 (S223). The limited distribution server 104 receives the link information in the link embedding unit 126.

The user (BLOG owner) terminal 101 transmits a thumbnail request (still picture request) to the limited distribution server 104, and it is received in the distribution request receiving unit 122 (S224). The distribution request receiving unit 122 transmits history notice to the contents viewing status management unit 125 (S225). The distribution request receiving unit 122 transmits a distribution command to the thumbnail distribution unit 123 (S226). On receiving the distribution command, the thumbnail distribution unit 123 distributes images to the BLOG owner terminal 101 (S227).

On the other hand, as for fragmentary motion pictures, the user terminal 100 transmits a fragmentary motion picture request to the limited distribution server 104, and it is received in the distribution request receiving unit 122 (S228). On receiving the fragmentary motion picture request, the distribution request receiving unit 122 inquires of the distribution judgment unit 121 whether a requested scene is a viewable section (S229). The distribution judgment unit 121 acquires necessary information from the access history managed by the contents viewing status management unit 125 according to the distribution limitation criteria specified in Step 222 (S231, S232), and determines whether a specified scene can be distributed. The distribution judgment unit 121 transmits the result of determining that the scene can be distributed, to the distribution request receiving unit 122 (S233). The distribution request receiving unit 122 transmits history notice to the contents viewing status management unit 125 (S234). The distribution request receiving unit 122 transmits a distribution command to the motion picture distribution unit 124 (S236). On receiving the distribution command, the motion picture distribution unit 124 transmits a link request to the link embedding unit 126 (S237). The link embedding unit 126 transmits link information to the motion picture distribution unit 124. The motion picture distribution unit 124 embeds link information received from the link embedding unit 126 and distributes motion pictures to the user terminal 100.

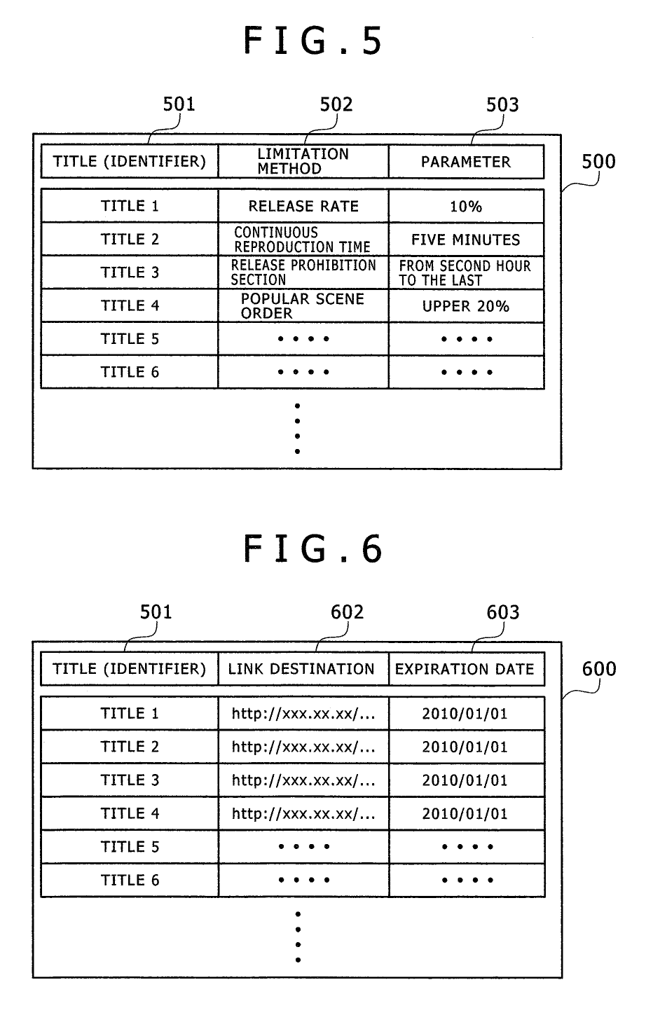

Referring to FIG. 5, the following describes concrete contents of distribution limitation criteria sent from the management terminal 106. FIG. 5 is a drawing for explaining distribution limitation criteria. In FIG. 5, distribution limitation criteria 500 includes plural sets of three pieces of information, titles (identifiers) 501 for identifying contents (motion pictures) to which the criteria are applied, limitation methods 502, and limitation parameters 503 corresponding to the limitation methods. The titles 501 of contents include specification of plural titles by genre specification and regular expression. The limitation methods 502 include a release method specifying the ratio of releasable scenes to the whole contents, a continuous reproducible time specification method guaranteeing that continuous scenes are not released, a release prohibition section specification method prohibiting the release of sections specified in advance, and a popular scene order method. For the release ratio method and the popular scene order method, a percent (%) parameter 503 is specified. For the continuous reproducible time and the release prohibition specification method, a time (minute, second, millisecond) parameter 503 is specified. Units specified as the parameter may include other than the above.

Referring to FIG. 6, the following describes concrete contents of link information sent from the video distribution server 103. FIG. 6 is a drawing for explaining link information. In FIG. 6, the link information includes plural sets of three pieces of information, titles (identifiers) 501 for identifying contents, link destinations 602, expiration dates 603 of corresponding links.

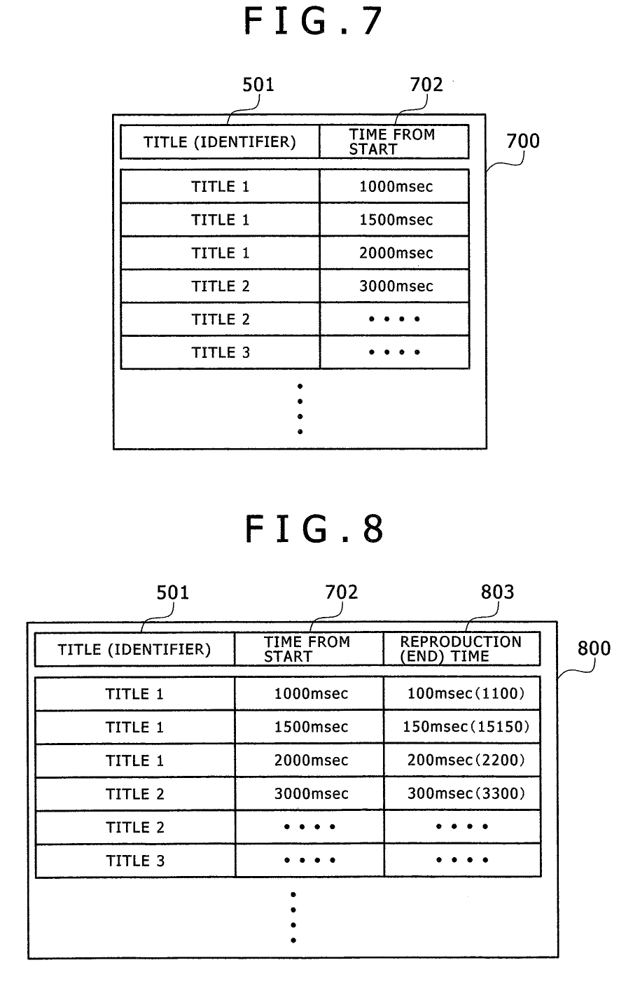

Referring to FIG. 7, the following describes concrete contents of a thumbnail request sent from the user (BLOG owner) terminal 101. FIG. 7 is a drawing for explaining a thumbnail request. In FIG. 7, a thumbnail request 700 includes titles (identifiers) 501 for identifying contents, and elapsed time 702 from the start for identifying a scene within a corresponding content. When plural scenes are requested, plural requests may be collectively sent.

Referring to FIG. 8, the following describes the concrete contents of a motion picture request sent from a user terminal. FIG. 8 is a drawing for explaining a motion picture request sent by one user. In FIG. 8, a motion picture request 800 includes titles (identifiers) 501 for identifying contents, elapsed time 702 from the start for identifying a scene within the contents, and reproduction time (or end time) 803. When plural scenes are required, plural requests may be collectively sent, and motion pictures may be produced by tying plural discontinuous scenes together.

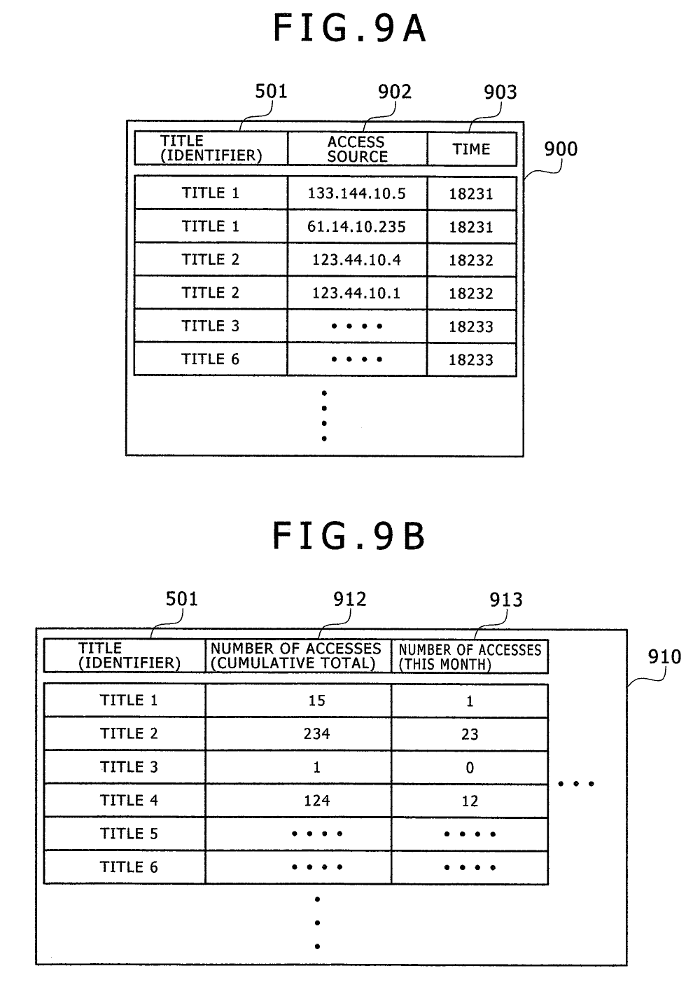

Referring to FIGS. 9A and 9B, the following describes the concrete contents of access history information sent from the limited distribution server 104 to the video distribution server 103. FIGS. 9A and 9B are drawings for explaining access history information. In FIG. 9, the access history information falls into two categories, unprocessed data 900 of FIG. 9A and statistical information 910 of FIG. 9B. The unprocessed data 900 is a list of titles (identifiers) 501 for identifying contents, time 903 when a request to the contents was made, and access sources 902. The statistical information 910 includes sets of a title (identifier) 501 for identifying contents, the cumulative number of accesses to the contents 912, and statistical information 913 cumulatively obtained unprocessed data counted by different methods such as year, month, time series, and a day of the week. Other than the above-described information may be added to the statistical information 910.

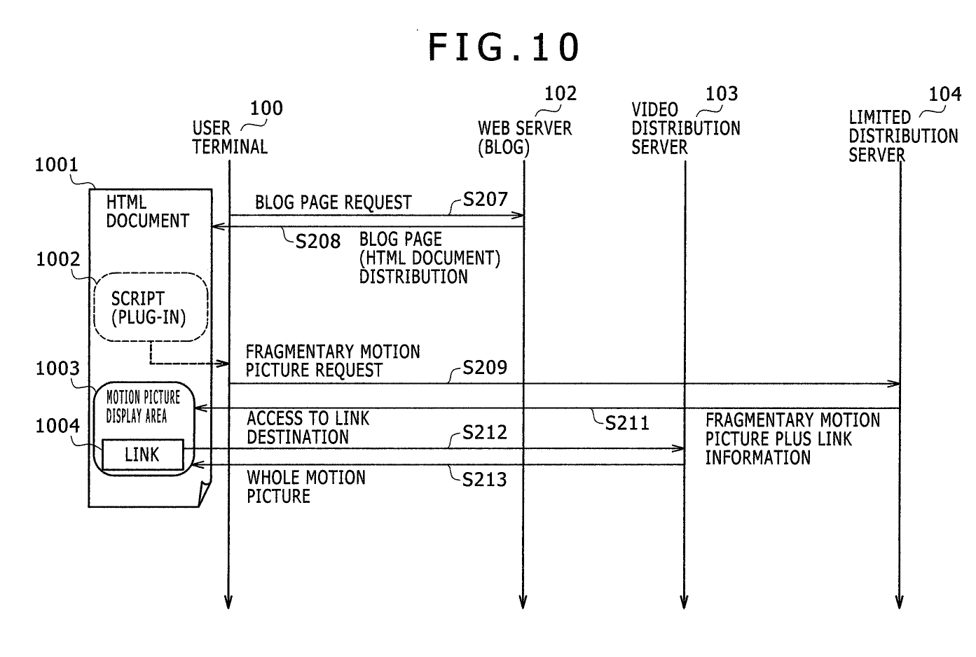

Referring to FIG. 10, the following details a processing sequence of a user terminal. FIG. 10 is a processing sequence diagram of a user terminal. In FIG. 10, the user terminal 100 acquires an HTML document 1001 from the WEB server 102 in Step S207. The HTML document 1001 contains a script (or plug-in tag) 1002 serving as a trigger for sending a motion picture request. The user terminal 100 interprets the script 1002 and sends a motion picture request to the limited distribution server 104 (S209). On receiving the motion picture request, the limited distribution server 104 sends required motion picture data and link information to the user terminal 100 (S211). The motion picture data is displayed in a motion picture display area 1003 of the user terminal 100. When the motion picture display area 1003 is embedded as one of components of HTML document, it may be an area independent from the above pages. Link information 1004 is displayed on the motion picture display area 1003 or as one of components of HTML document in the form of a clickable component such as anchor link or form button. When a displayed button (anchor link) 104 is clicked, a motion picture specified in the link information is downloaded from the video distribution server 103 and displayed in the motion picture display area 1003 (S213). The link information may contain links other than links to motion pictures on the video distribution server 103; it may contain a link to a WEB site for page movement to the WEB site, and links are enabled to other motion pictures on the limited distribution server 104. When a link is made to a link destination requiring authentication, by clicking the link and displaying an input form, a user ID and a password are acquired. To send the ID and the password to a link destination, the communication in Steps 212 and 213 may include plural steps.

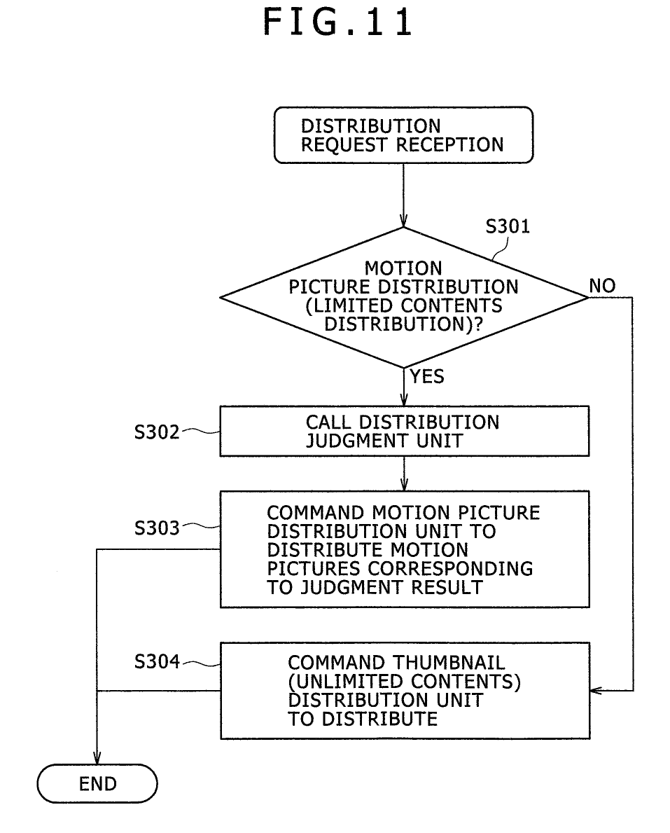

Referring to FIG. 11, the following describes an operation algorithm of the distribution request receiving unit. FIG. 11 is an operation flowchart of the distribution request receiving unit. In FIG. 11, on receiving a distribution request, the distribution request receiving unit 122 determines whether the contents require distribution judgment with distribution limitation criteria established (S301). When the contents require distribution judgment (S301: YES), the distribution request receiving unit calls the distribution judgment unit 121 (S302), commands the motion picture distribution unit 124 to distribute motion pictures according to the distribution judgment result (S303), and terminates. When Step 301 results in NO, the distribution request receiving unit commands the thumbnail distribution unit 123 to distribute a thumbnail (S304), and terminates.

Referring to FIG. 12, the following describes the operation algorithm of the distribution judgment unit. FIG. 12 is an operation flow of the distribution judgment unit. In FIG. 12, when distribution judgment is requested, the distribution judgment unit 121 determines whether judgment criteria corresponding to relevant contents exist (S311). When they exist, it acquires them (S312). When distribution judgment criteria are not established in Step 311 (N), it conveys distribution rejection (S321) and terminates.

Following Step 312, the distribution judgment unit 121 confirms the type of limitation criteria (S313 to S316), and determines whether distribution is legal according to the limitation criteria (S317 to S320). It first determines whether the limitation criteria are the release rate method (S313), and if not so, determines whether the limitation criteria are the continuous reproduction time method (S314). If not so, it determines whether the limitation criteria is the prohibition section method (S315), and further if not so, it determines whether the limitation criteria are popular order (S316). When all criteria are not satisfied, it conveys distribution rejection (S321) and terminates.

When any of the above-described limitation criteria is satisfied, the distribution judgment unit conveys distribution rejection according to the judgment result (S321), or conveys distribution approval (S322), and terminates.

When no distribution judgment criteria are set, a change to distribution approval may be made. Behavior not satisfying criteria may be performed after a change to distribution approval. Limitation criteria may be added besides the above-described four methods; in this case, the type of the added limitation criteria is confirmed after the confirmation of the type of limitation criteria in Step 316.

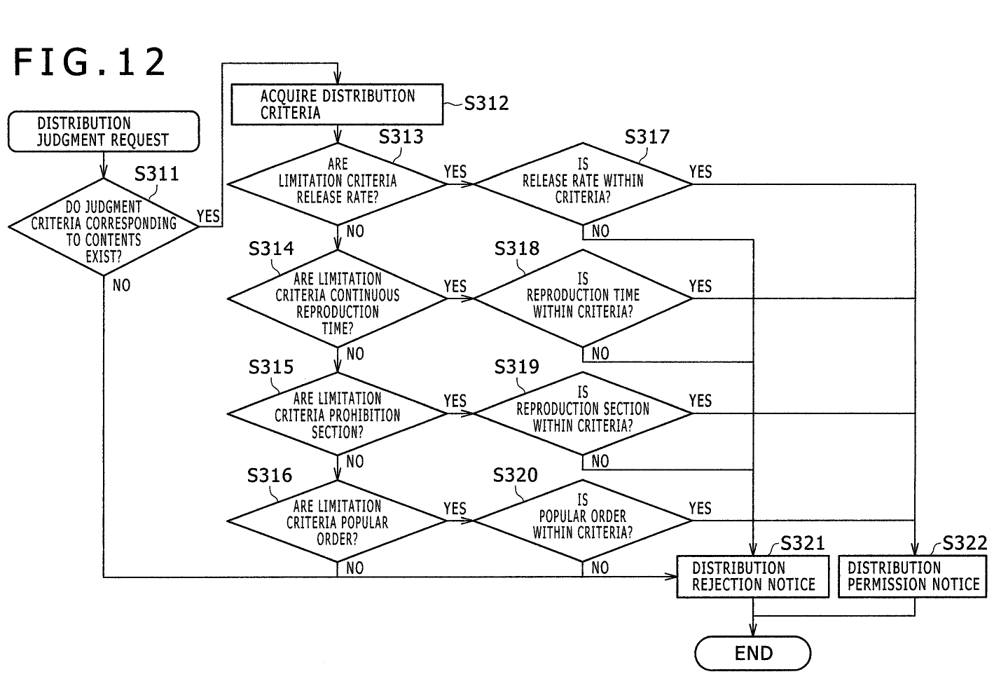

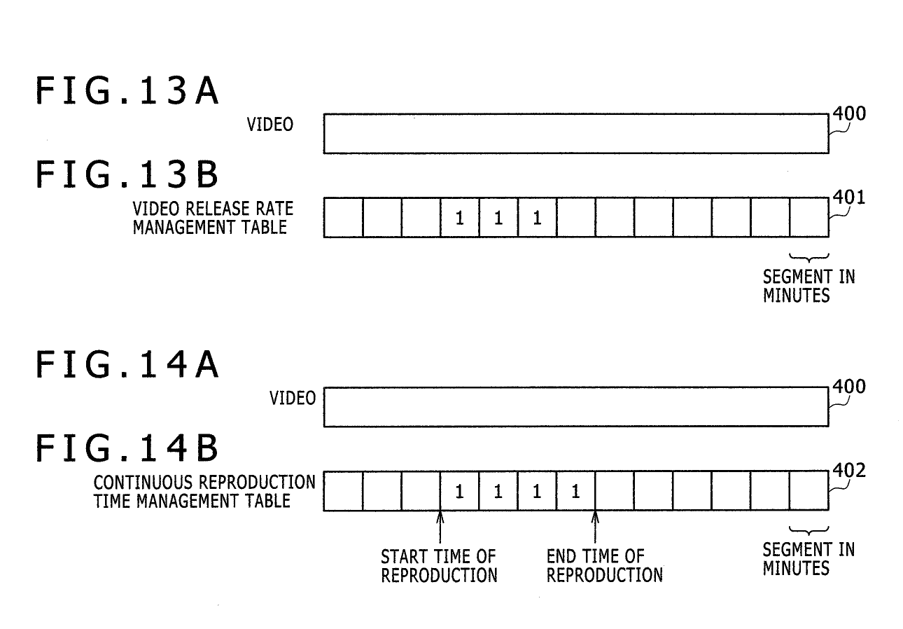

Referring to FIG. 13, the following describes the determination of distribution judgment based on release rates. FIGS. 13A and 13B are drawings for explaining the determination of distribution judgment based on release rates. FIG. 13A shows time elapse of video, and FIG. 13B shows a video release rate management table. For video data 400, a video release rate management table 401 showing whether individual segments produced by splitting the video data into plural segments (one-minute unit) have already been released is provided. For a request from the user 100, each time video data is released, a release flag “1” is set at corresponding segments of the table 401. When the number of released segments reaches a predetermined release rate, other than segments at which the release flag has already been set is rejected for distribution. This assures that the number of video fragments flowing out to the Internet is below a release rate set in distribution limitation criteria. Moreover, since the limited distribution device holds only a bit map of the video release rate management table, it does not need to store video data for release. The unit of segments is not limited to one minute.

Referring to FIGS. 14A and 14B, the following describes the determination of distribution judgment based on continuous reproduction time. FIGS. 14A and 14B are drawings for explaining the determination of distribution judgment based on continuous reproduction time. FIG. 14A shows time elapse of video, and FIG. 14B shows a continuous reproduction time management table. Like distribution limitation by release rates, for video data 400, a video release rate management table 402 showing whether individual segments produced by splitting the video data into plural segments (one-minute unit) have already been released is provided. When an attempt is made to set a release flag at an area beyond continuous reproduction time determined from reproduction start time and reproduction end time, the distribution judgment unit 121 rejects distribution. The distribution judgment unit 121 also rejects distribution when a requested reproduction range itself exceeds continuous reproduction time (when Expression 1 is not satisfied).

Reproduction end time−reproduction start time<continuous reproduction time Expression 1

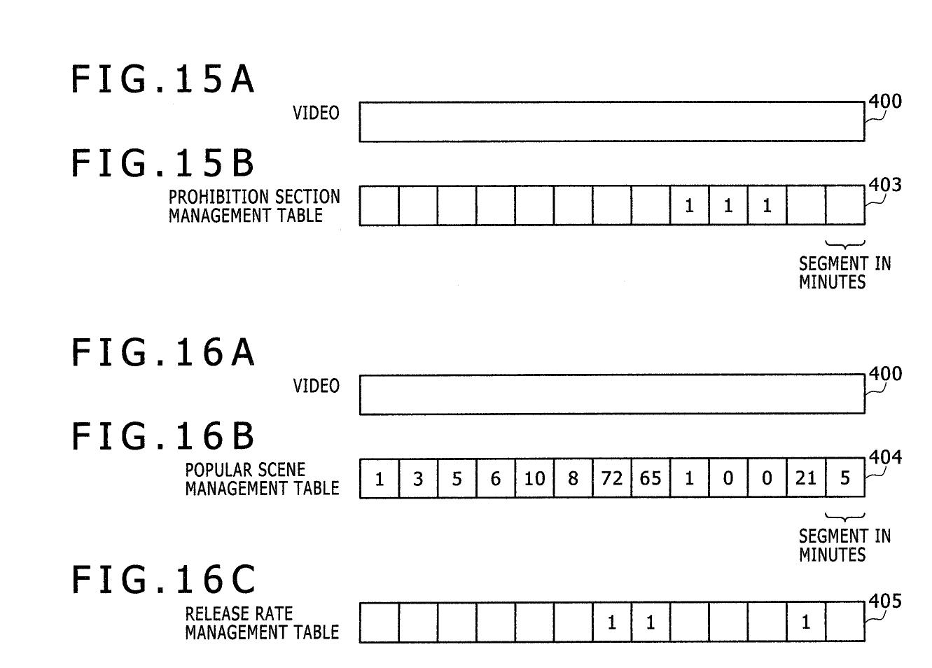

Referring to FIG. 15, the following describes the determination of distribution judgment based on release prohibition sections. FIG. 15 is a drawing for explaining the determination of distribution judgment based on release prohibition sections. In FIG. 15, FIG. 15A shows time elapse of video, and FIG. 15B shows a prohibition section management table. For video data 400, a prohibition section table 403 showing whether individual segments produced by splitting the video data into plural segments (one-minute unit) may be released or are prohibited from release is provided. With a prohibition flag “1” set at release prohibition sections in advance, if there is no prohibition flag within a reproduction range requested from the user 100, the distribution judgment unit 121 approves distribution, and if there are prohibition flags, the distribution judgment unit 121 rejects distribution.

Referring to FIGS. 16A to 16C, the following describes the determination of distribution judgment based on popular scene order. FIGS. 16A to 16C are drawings for explaining the determination of distribution judgment based on the order of popular scenes. FIG. 16A shows time elapse of video, FIG. 16B shows a popular scene management table, and FIG. 16C shows a release range management table. For video data 400, the popular scene management table 404 in which the number of requests (the number of accesses) of individual segments produced by splitting video data into plural segments (one-minute unit) is counted, and the release range management table 405 that manages release ranges are provided. Each time a request occurs for a scene (segment), the value of the segment of the popular scene management table 404 is counted up. Next, the release flag is set in the release range management table 405 in order of segments having decreasing counted values on the popular scene management table 404. The distribution judgment unit 121 rejects a distribution request to segments for which the release flag is not set.

Besides the above-described criteria, various distribution limitation criteria may be added, such as unpopular order release that sets the release flag in order of segments having the increasing number of accesses. Release is made in the fashion of “first come, first served” in the determination of distribution judgment based on release rates, while popular scenes can be released in the determination of distribution judgment based on popular scene order. The popular scene management table may be created based on the number of thumbnail requests.

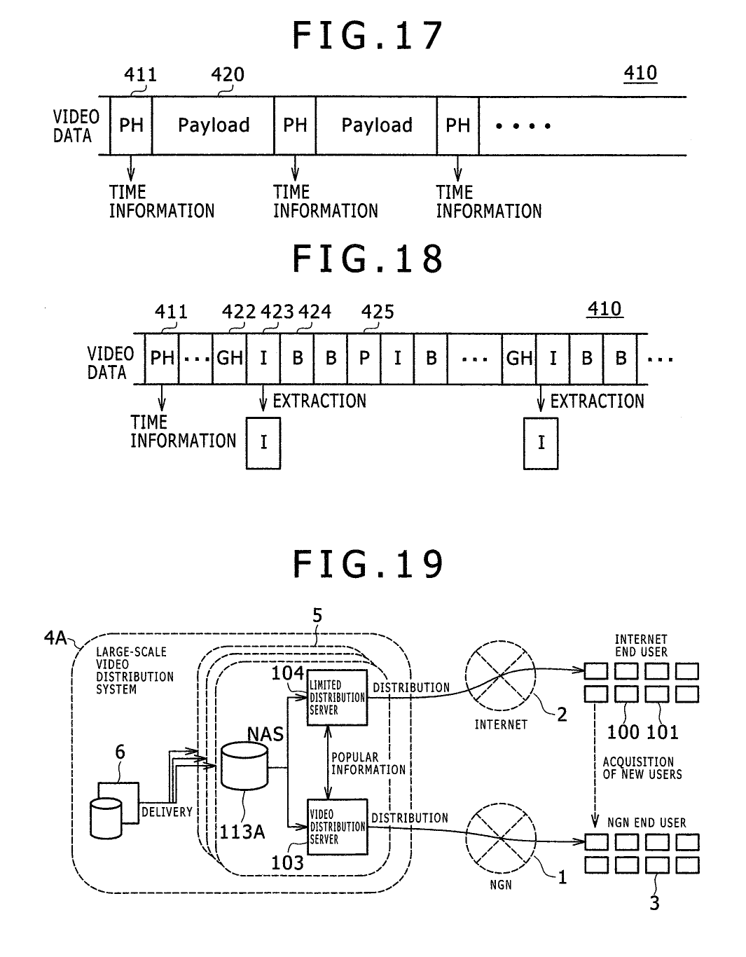

Referring to FIG. 17, the following describes the procedure of distributing motion pictures in a range requested at a user terminal. FIG. 17 is a block diagram of MPEG streams. In FIG. 17, an MPEG stream 410 is structured to have repetition of a pack header (PH) 411 and payload 420. The payload 420 stores image data, and the pack header 411 stores elapsed time from the start of motion pictures of image data. The motion picture distribution unit 124 searches a pack header in which time closest to start time requested at the user terminal 100 is recorded, and a pack header in which time closest to end time is recorded, and distributes images between them, thereby dynamically extracting and distributing motion pictures in a range requested at the user terminal 100.

Referring to FIG. 18, the following describes the procedure of extracting and distributing still pictures requested at a user terminal. FIG. 18 is a block diagram of an MPEG stream. An MPEG stream includes repetition of the pack header 411 and payload following the pack header 411. The payload includes repetition of Group of Pictures (GOP) header 422, I picture 423, B picture 424, and P picture 425. The I picture 423, B picture 424, and P picture 425 except the GOP header 422 are image data. The B picture 434 and P picture 425 except the I picture are differential images, and have only information of differences from preceding and following images. On the other hand, the I picture 423 has complete image data as a still picture. Usually, the I picture 423 is immediately after the GOP header 422. Accordingly, on receiving a request from a still picture from the user terminal 100, the thumbnail distribution unit 123 searches a back header closest to a request time, and extracts and distributes the I picture 423 immediately after the first GOP header 422 after the back header. Thereby, the limited distribution server 104 can dynamically extract and distribute still pictures requested from the user terminal 101.

According to this embodiment, in an attempt to partially view scenes different depending on viewers, there is no need to prepare plural motion picture fragments, and the effect of reducing disk drive capacity for storing a motion picture file can be expected. The effect of reducing disk drive capacity for storing a motion picture file can be expected. By combined use of the function to extract still pictures from motion pictures for distribution, also in the case where motion pictures and any scene still pictures of the motion pictures are distributed at the same time, the effect of reducing disk drive capacity can be expected. Besides, when it is found that there are problematic scenes in motion pictures after the whole motion pictures have been released, only the problematic scenes can be limited in viewing without editing original motion pictures. Criteria dynamically determined after motion pictures are released, such as popular scenes, can be set as viewing limitation criteria. Such dynamic viewing limitation is difficult to achieve with a combination of the conventional methods. Furthermore, because of the function to embed links for guiding viewers to other sites in the motion pictures to be distributed, in the case where part of motion pictures is released for promotion, the effect of the promotion can be expected to further increase.

The above-described embodiment has been described with distinction between general users and BLOG owners. However, it is acceptable for general users to request a thumbnail. Likewise, it is acceptable for BLOG owners to accept unlimited image distribution.

### Second Embodiment

Referring to FIG. 19, the following describes a vide distribution system of a second embodiment. FIG. 19 is a block diagram of a video distribution system. In FIG. 19, a large-scale video distribution system 4A includes a central station 6 and plural edge stations 5 each provided for each region. Each edge station 5 includes a video distribution server 103 and the limited distribution server 104, and end users of the NGN 1 receive video distribution service from the nearest edge station 5. When new motion pictures are distributed, motion picture data is delivered from the central station 6 to each edge station 5. It is desirable to share the motion picture data if possible because it generally has a large size. Therefore, the limited distribution server 104 and the video distribution server 103 share a motion picture file, using a common Network Attached Storage (NAS) device 113A.

The limited distribution server 104 distributes limited images to the end users 100 and 101 of the Internet via the Internet 2.

In this embodiment, since the NAS device is used, the video distribution server and the limited distribution server can share motion picture files.

### Third Embodiment

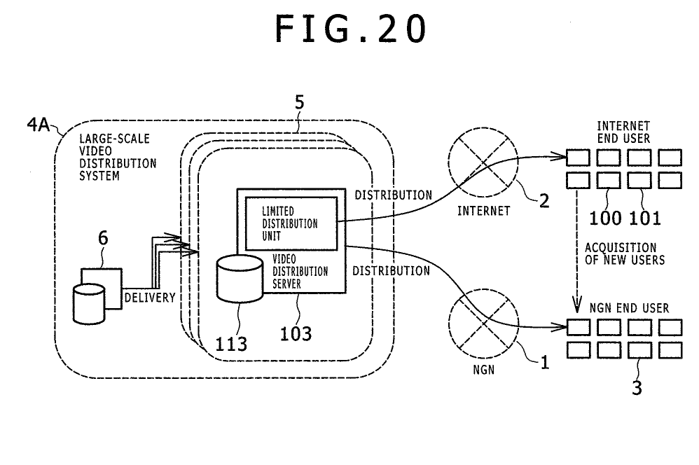

Referring to FIG. 20, the following describes a video distribution system of a third embodiment. FIG. 20 is a block diagram of a video distribution system.

In FIG. 20, a large-scale video distribution system 4B includes a central station 6 and plural edge stations 5 each provided for each region. Each edge station 5 includes a distribution server 103A incorporating the function of the limited distribution server as a limited distribution unit 104A, and an end user 3 of the NGN 1 receives video distribution service at the nearest edge station 5. The end users 100 and 101 of the Internet 2 can receive distribution of limited images from the limited distribution unit 104A of the distribution server 103 of the nearest edge station 5.

In this embodiment, since a limited distribution function is incorporated in the video distribution server, the number of motion picture files may one and a NAS device is not mandatory.

According to the present invention, different viewing limitation criteria may be set in advance for different titles to limit the viewing of specific scenes of motion pictures. Thereby, only part of motion pictures can be released without editing original motion pictures.

What is claimed is:

1. A distribution device that distributes video data stored in a storage unit to end users via a network, comprising:
a distribution judgment unit that determines whether distribution is legal based on distribution judgment criteria received from a management terminal; and
a motion picture distribution unit that transmits motion picture data with a limitation imposed on video data to a first user.

2. The distribution device according to claim 1, transmitting still picture data extracted from the video data to a second user, based on a thumbnail request received from the second user.

3. The distribution device according to claim 1,
wherein a link to motion picture data having no limitations is attached to the motion picture data.

4. The distribution device according to claim 1,
wherein said limitation is selected from among release rate, continuous reproduction time, release prohibition section, popular scene, and unpopular scene.

5. The distribution device according to claim 1, further comprising a viewing status management unit that manages the distribution request,
wherein access history is transmitted at a predetermined time.

6. A distribution system comprising a first distribution device connected to a first network, and a second distribution device connected to a second network,
wherein said first distribution device includes a distribution judgment unit that determines whether distribution is legal based on distribution judgment criteria received from the management terminal, and a motion picture distribution unit that transmits first motion picture data with a limitation imposed on video data to a first user, based on a distribution request received from the first user, and the judgment of the distribution judgment unit, and
wherein said second distribution device transmits second motion picture data corresponding to a link attached to the first motion picture data to the first user.

7. The distribution system according to claim 6, transmitting still picture data to a second user, based on a thumbnail request received from the second user.

8. The distribution system according to claim 6,
wherein said first distribution device transmits access history to the second distribution device at a predetermined time.

9. A distribution method comprising the steps of:
receiving a distribution request from a user;
determining whether distribution is legal, for the distribution request; and
transmitting links to first motion picture data with a limitation imposed on video data, and second motion picture data with no limitation imposed to the user.

10. The distribution method according to claim 9, further comprising the steps of:
receiving a thumbnail request from the user; and
transmitting links to still picture data and the first motion picture data to the user.

11. The distribution method according to claim 9, further comprising the step of:
transmitting access history at a predetermined time.
